(19) United States
(12) Patent Application Publication
(10) Pub. No.: US 2026/0148293 A1
(43) Pub. Date: May 28, 2026

(54) COMPUTER-IMPLEMENTED METHODS, SYSTEMS COMPRISING COMPUTER-READABLE MEDIA, AND ELECTRONIC DEVICES FOR OPEN BANKING RISK MODEL TESTING FRAMEWORK

(71) Applicant: Mastercard International Incorporated, Purchase, NY (US)

(72) Inventors: Satish Bandaru, South Jordan, UT (US); Natesh Babu Arunachalam, Herriman, UT (US); Swati Saini, Jaipur (IN)

(73) Assignee: Mastercard International Incorporated, Purchase, NY (US)

(21) Appl. No.: 18/959,184

(22) Filed: Nov. 25, 2024

(51) Int. Cl. G06Q 40/03; G06Q 40/02

(52) U.S. Cl. CPC G06Q 40/03; G06Q 40/02

(57) ABSTRACT

A computer-implemented method for testing a risk model trained to output a risk determination for open banking transactions that includes: unit testing the risk model implemented in an application programming interface (API) platform; performing manual and automated feature validation of the risk model by comparing feature outputs from the risk model to expected feature output values; performing functional validation of the risk model according to an accuracy metric; benchmark testing the risk model, implemented in the API platform, using simulated scenario test data sets; load testing the risk model; after performing the foregoing, deploying the risk model as a production risk model with a web portal in a production environment; and dog-food testing the production risk model using a plurality of simulated scenario test data sets configured to simulate real production usage.

### FIELD OF THE INVENTION

The present disclosure generally relates to computer-implemented methods, systems comprising computer-readable media, and electronic devices for an open banking risk model testing framework.

### BACKGROUND

Open banking services provide secure platforms for the aggregation, exchange and validation of financial information. The platforms often enable greater visibility for lenders into potential borrowers' financial lives to support better decisioning. They also help banks and other financial institutions interact with consumers and one another, as well provide services to and consented data sharing with entities such as credit reporting bureaus and the like.

Serving as an information intermediary between so many diverse entities gives rise to technological challenges, including relating to implementation of machine learning (ML) models for generating recommendations or predictions. For example, the unique intermediary positioning and corresponding hardware configurations, as well as the inherent structure (or lack thereof) of open banking data, present barriers to efficient and effective generation, testing and rollout of ML models.

Present ML model testing and rollout solutions are not adapted for such open banking uses.

This background discussion is intended to provide information related to the present invention which is not necessarily prior art.

### BRIEF SUMMARY

Embodiments of the present technology relate to computer-implemented methods, systems comprising computer-readable media, and electronic devices for testing a risk model trained to output a risk determination for open banking transactions. The embodiments provide a technological mechanism for efficient and effective rollout of such risk models for provision of such services in a production environment. Namely, embodiments of the present invention provide efficient and effective testing pipelines and approaches which unexpectedly meet and exceed expectations for performance, accuracy and responsiveness at and following deployment.

More particularly, in an aspect, non-transitory computer-readable storage media having computer-executable instructions stored thereon for testing a risk model trained to output a risk determination for open banking transactions may be provided. When executed by at least one processor the computer-executable instructions cause the at least one processor to: analyze historical open banking platform data according to open banking service business domains to determine a set of boundary conditions for each of the business domains; apply the sets of boundary conditions to generate simulated scenario test data sets, each of the plurality of simulated scenario test data sets corresponding to one of the business domains; benchmark test the risk model, the risk model being implemented in an application programming interface (API) platform, using the simulated scenario test data sets as input to generate corresponding outputs comprising risk determinations for each of the open banking service business domains; and determine precision of the outputs according to expected or prior values. The instructions, when executed, may cause the at least one processor to perform additional, less, or alternate actions, including those discussed elsewhere herein.

In another aspect, non-transitory computer-readable storage media having computer-executable instructions stored thereon for testing a risk model trained to output a risk determination for open banking transactions may be provided. When executed by at least one processor the computer-executable instructions cause the at least one processor to: load test the risk model, the risk model being implemented in an application programming interface (API) platform including pre- and post-processing units, using open banking test data as input to generate corresponding outputs comprising risk determinations; determine one or more of the following metrics for the outputs: time to calculate features, time to prediction, and end-to-end time; compare the one or more determined metrics to corresponding performance criteria; based on the comparison, retrain the risk model; load test the retrained risk model, implemented in the API platform, to generate corresponding second outputs comprising second risk determinations; recalculate the one or more determined metrics based on the second outputs; compare the one or more recalculated determined metrics to the performance criteria; and based on the comparison of the one or more recalculated determined metrics to the performance criteria, determine acceptable performance of the retrained risk model. The instructions, when executed, may cause the at least one processor to perform additional, less, or alternate actions, including those discussed elsewhere herein.

In still another aspect, non-transitory computer-readable storage media having computer-executable instructions stored thereon for testing a risk model trained to output a risk determination for open banking transactions may be provided. When executed by at least one processor the computer-executable instructions cause the at least one processor to: unit test the risk model implemented in an application programming interface (API) platform, the unit testing including independently testing processes of the API platform for satisfactory performance; perform manual and automated feature validation of the risk model by comparing feature outputs from the risk model to expected feature output values, the manual feature validation including manual generation of a first set of the expected feature output values and the automated feature validation including automated generation of a second set of the expected feature output values; perform functional validation of the risk model by comparing risk determination outputs of the model to expected values for the functional validation risk determination outputs to determine performance according to an accuracy metric; benchmark test the risk model, the risk model being implemented in the API platform, using simulated scenario test data sets as input to generate corresponding outputs comprising risk determinations for each of a plurality of open banking service business domains; load test the risk model, the risk model being implemented in the API platform, using open banking test data as input to generate corresponding outputs comprising risk determinations and including calculating load testing metrics for the outputs of the load test; after performing the unit testing, the manual and automated feature validation, the functional validation, the benchmark test and the load test, deploy the risk model as a production risk model with a web portal in a production environment; and dog-food test the production risk model by establishing communication between open banking accounts corresponding to open banking customers and inputting, via the open banking accounts, simulated scenario test data sets configured to simulate real production usage to generate corresponding outputs comprising risk determinations. The instructions, when executed, may cause the at least one processor to perform additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for testing a risk model trained to output a risk determination for open banking transactions in accordance with embodiments of the present invention;

FIGS. 2, 3 and 4 illustrate various components of exemplary computing devices shown in block schematic form that may be used with the system of FIG. 1;

FIG. 5 illustrates at least a portion of the steps of an exemplary computer-implemented method for testing a risk model trained to output a risk determination for open banking transactions in accordance with embodiments of the present invention;

FIG. 6 illustrates at least a portion of the steps of an exemplary computer-implemented method for testing a risk model trained to output a risk determination for open banking transactions in accordance with embodiments of the present invention; and

FIG. 7 illustrates at least a portion of the steps of an exemplary computer-implemented method for testing a risk model trained to output a risk determination for open banking transactions in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for testing, rollout and monitoring of ML models for generating recommendations and predictions for open banking transactions are limited, haphazard and ineffective. Embodiments of the present invention provide efficient and effective testing and deployment pipelines and approaches which unexpectedly meet and exceed expectations for performance, accuracy and responsiveness at and following deployment.

According to embodiments of the present invention, a technological mechanism is provided for improved ML model development, testing and rollout and corresponding provision of open banking services that includes particularized testing and monitoring tied to specific data sets and application configurations. These particularized pipelines have been found to generate unexpectedly positive results when implemented with ML risk models in an open banking production environment.

### Exemplary System

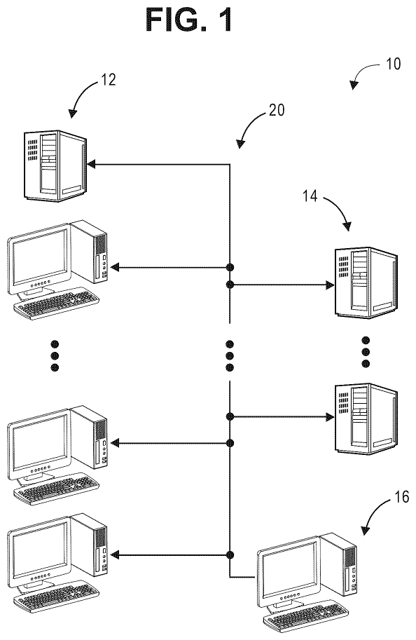

FIG. 1 depicts an exemplary environment 10 for testing a risk model trained to output a risk determination for open banking transactions, according to embodiments of the present invention. The environment may include a plurality of client devices 12, a plurality of servers 14, a service device 16, and a communication network 20. Client devices 12, servers 14 and the service device 16 may be located within network boundaries of an organization, such as a corporation or the like that provides open banking services. One or more client devices 12 and servers 14 may also be outside the network boundaries of the organization.

The communication network 20 may be partly or even mostly internal to the organization, for example where the servers 14 manage databases and/or APIs of and/or provide cloud-based services to and under the management of the organization, and a client device 12 is also under the management of the organization. Also or alternatively, the client devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the client devices 12, servers 14, service device 16 and/or all or some of the virtual resources managed thereby, may at least partly comprise a secure network computing environment. Alternatively or in addition, the service device 16 may manage access and transmissions between and among itself and the client devices 12 and servers 14 under an authentication management framework. For example, each user of a client device 12 may be required to complete an authentication process to access secure data provided via the servers 14 and/or the services provided by service device 16. In one or more embodiments, any authentication management framework may be utilized including, without limitation, custom frameworks.

For example, the service device 16 may host, aggregate and analyze data and host and provide access to/use of applications comprising open banking services. In one or more embodiments, the open banking services comprise data aggregation, analysis, management and data sharing services whereby consumers and businesses may subscribe for consented and controlled sharing of data with financial service providers and/or institutions. Moreover, the service device(s) 16 may manage risk model generation, test data generation, risk model testing, risk model deployment and API platform configuration, and deployed risk model monitoring operations discussed herein.

Data subjects (e.g., consumers and businesses seeking financial services from financial service providers) may subscribe for the open banking services and accordingly be assigned open banking accounts managed by the service device(s) 16, and the subjects may identify one or more financial accounts or data/documents sources from which to share data and/or directly provide copies of financial and identification information (e.g., access credentials) and documents. The data subjects may also consent to controlled sharing of such financial, identity- and/or location-related information with the open banking services of the service device 16 and, in turn, with consented data recipients (e.g., the financial service providers).

In turn, data recipients (e.g., lenders, credit score agencies, credit card service providers, or other financial institutions or financial service providers) may subscribe and access the open banking services and subject data, for example to calculate credit scores, open new financial accounts, provide advice about improving credit scores, approve loan requests from data subjects, and perform other financial services. In one or more embodiments, data recipients may be considered customers of the open banking service platform, and may be organized or categorized according to business domains (e.g., groups of services provided by the customers and/or open banking services enrolled in and/or utilized by the customers). In one or more embodiments, business domain categorization may be based on merchant category code (MCC) and/or other standardized taxonomy(ies). The business domain categorization may also or alternatively rely on volume of requests or queries issued to the risk model, for example according to tiered ranges of queries per unit time.

The consented data provided with the permission of data subjects may be provided directly (e.g., via upload from client devices 12) and/or by directive of the data subjects given to the service device 16 and/or one or more servers 14. For example, a data subject may provide access credentials used to access server(s) 14 which host and/or gather data from financial institution or service provider application programming interfaces (APIs), with such APIs providing access to the data subject's financial account records. The data subject may thereby direct the server 14, whether directly or indirectly, to provide the service device 16 with all or some such financial account records, and may establish conditions and parameters around such sharing and/or around subsequent sharing by the service device 16 with data recipients (e.g., financial service providers also subscribed to the open banking services). Consenting to and retrieval of data subject data may take a variety of forms, and utilize a variety of data sources having a variety of formats, within the scope of the present invention.

Accordingly, data subjects and data recipients may subscribe for the open banking services, for example through the use of and access provided by service device 16. The open banking services may be provided by the service device 16 to and/or via the client devices 12 and/or servers 14. It should again be noted that the service provider or organization providing the open banking services may itself include client devices 12 and service devices 16, for example where the risk model(s) of embodiments of the present invention are deployed for testing and/or production environments to one or more server(s) 14. The risk model may output one or more risk determinations relating to a subject putative or actual open banking platform transaction via the server(s) 14, as discussed in more detail below. The open banking service provider may also or alternatively include servers 14 acting as data sources, for example where the service provider has consented access to credit card transaction records and data of the data subjects and/or which may be accessed to enhance services performed by the open banking service provider.

One of ordinary skill will appreciate that embodiments may serve a wide variety of individuals and organizations (i.e., customers) and/or rely on a wide variety of data sources (and formats) and/or service providers within the scope of the present invention. It should also be noted that reference herein to a “business organization,” “corporation” or the like are made for ease of reference, and that embodiments of the present invention are equally applicable to individual users and/or partnerships subscribing to and/or providing open banking services.

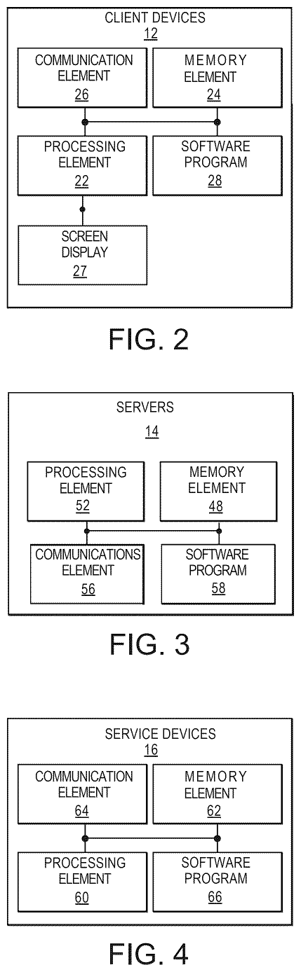

Turning to FIGS. 2 and 4, generally the client devices 12 and the service devices 16 may include tablet computers, laptop computers, desktop computers, workstation computers, smart phones, smart watches, and the like. In one or more embodiments, the client devices 12 and/or the service devices 16 may comprise server(s), examples of which are discussed in more detail below.

Client devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the client devices 12 may additionally include a screen display 27, which may comprise a user interface of the client device 12. In one or more embodiments, a client device 12 is operated by a customer requesting risk determination(s). In one or more embodiments, a client device 12 is operated by the open banking platform service provider and displays a dashboard or other test results and/or metrics (discussed in more detail below) on the display 27. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the client devices 12 and the service device 16 may include a software application or program 28, 66 configured with instructions for performing and/or enabling performance of at least some of the steps set forth herein. In an embodiment, the software programs 28, 66 each comprises instructions respectively stored on computer-readable media of a memory element 24, 62.

The servers 14 generally receive requests and/or consents for data sharing from the client devices 12—directly or indirectly via the service device 16—and expose or otherwise provide such subject data and other data to the service device 16 for intake, aggregation, analysis and consented sharing managed by the service device 16. In one or more embodiments, a service device 16 enrolls all or some of the client devices 12 and servers 14 and/or the resources embodied thereby for receipt of and/or participation in the open banking services. The servers may also or alternatively host the risk model(s), the application programming interface (API) platform in which such risk model(s) are implemented, and/or the risk model(s) and API platform integrated as a production risk model with a web portal, in each case for receiving input data and generating outputs comprising feature outputs and/or risk determination outputs for the service device 16 and/or devices of customers on behalf of the open banking services platform.

The servers 14 may comprise cloud servers, domain controllers, application servers, database servers, database web servers, file servers, mail servers, catalog servers or the like, or combinations thereof. In one or more embodiments, one or more data sources may be maintained by one or more of the servers 14. Generally, each server 14 may include a memory element 48, a processing element 52, a communication element 56, and a software program 58.

The communication network 20 generally allows communication between the client devices 12, the servers 14, and the service device 16, for example in conjunction with device enrollment, data acquisition, data consenting, data aggregation, data analysis and data sharing with recipient devices in connection with open banking services provided by the service device 16, risk model and API platform/web portal testing and deployment, and risk model monitoring and output analyses.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The client devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the client devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data queries or requests for services may be initiated via user applications embodied, controlled and/or executed by client devices 12, servers 14 and/or service device(s) 16. In an embodiment, access to user applications, client devices 12, servers 14 and/or service device(s) 16 is granted via one or more authentication framework(s) such as those outlined above, for example where account identification and consents are provided by one or both of the open banking service platform and the platform(s) of financial institution(s) at which data subjects hold accounts.

Data sources hosted by the servers 14 may utilize a variety of formats and structures within the scope of the invention. For instance, relational databases and/or object-oriented databases may embody the data sources, and may be exposed for queries by one or more corresponding APIs. One of ordinary skill will appreciate that—while examples presented herein may discuss specific types of operating systems and/or databases—a wide variety may be used alone or in combination within the scope of the present invention.

In one or more embodiments, the software program 58 of one or more of the servers 14 may translate data from the authentication management framework and/or from the client device(s) 12 into identity information for use in connection with authenticating individuals or end users (i.e., data subjects or consented data recipients) for access to data and services by the service device 16 and data recipients. One of ordinary skill will appreciate that a variety of user or data subject information—including, without limitation, credentials and/or biometric or device data—may comprise and/or be used to generate the identity information within the scope of the present invention. It is foreseen that the program 58 may function in connection with a variety of authentication frameworks without departing from the spirit of the present invention.

The program 58 may be configured with policies that define limits to data access, for example with respect to data volume and/or frequency/timing of access events, by the service device 16. In one or more embodiments, these may include financial institution (FI) rate limits. The program 58 may permit service device 16 and/or a service provider employee of the open banking service to have limited access to those aspects and data entries/records which are consented by the corresponding data subject (and, optionally, the financial institution(s)), including under the authentication management framework.

One of ordinary skill will appreciate that the software program 28 of one or more of the client devices 12 may similarly manage access by the service device 16 to aspects of the client devices 12 and/or data stored thereby, particularly where such aspects form a part of or relate to the consented data of the data subject. In one or more embodiments, the service device 16 negotiates such limits (e.g., imposed by financial institutions operating the server(s) 14 and/or by client device 12) by prioritizing data access and aggregation for open banking services which require more frequent access, are in more demand, or otherwise to optimize and balance business objectives of the open banking service provider.

In one or more embodiments, the service device 16 implements an open banking service for client devices 12 and/or servers 14 controlled by data recipient subscribers. The data recipient subscribers (or customers), for example, may calculate credit scores, open new financial accounts, provide advice about improving credit scores, approve loan requests and otherwise perform financial-related tasks for data subjects. In one or more embodiments, such data recipient subscriber services inform categorization of customers into business domains.

In one or more embodiments, performance of the open banking services includes the service device 16 processing queries from one or more of the devices 12, 14 about, to support and/or as a part of the open banking services. In one or more embodiments, the queries are requests for risk determinations of a risk model relating to open banking transactions, and include input data for the risk model used to generate such risk determination outputs.

The risk model trained, implemented, deployed and/or monitored by the open banking services platform (e.g., at the direction of service device 16 and, optionally, via one or more server(s) 14) may generate risk determinations relating to any type of open banking transaction. Risk determinations generally provide a numerical or tiered assessment of a risk aspect of a putative financial transaction assessed and/or facilitated by the open banking services platform. For example, a customer may be a lender, a putative transaction may be a requested loan, and the risk determination may comprise a numerical score (e.g., on a normalized score scale) representing the likelihood the borrower will default on one or more payments. For another example, a customer may be a merchant, a putative transaction may be a payment for goods or services of the merchant, and the risk determination may comprise a numerical score representing the likelihood that the payment will successfully be completed if initiated within a given timeframe.

More broadly, risk determinations may comprise numerical or tier-based assessments (e.g., “Likely,” “Somewhat Likely,” or “Unlikely”) of: the likelihood of open banking transaction-related events such as negative payment events (e.g., the likelihood of a negative payment event, such as a missed payment or overdraft, within the next 24 months); the credit worthiness of an accountholder (e.g., a credit score that combines open banking data such as consumer-contributed data, including checking and savings account data, with consumer credit information from credit bureau(s)); and/or other risk aspects of putative open banking transaction events.

The risk model may comprise machine learning (ML) features, or measurable properties of data used as input for the risk model, which might also be thought of as variables or attributes of the risk model. It should be noted that features may not simply be data values extracted from raw data, but may instead be derived, calculated, cleaned, shaped, and/or structured from such raw data into features that the risk model can use. Such pre-processing operations may receive raw data (such as open banking data discussed above, credit bureau data, and/or other financial data regarding a putative transacting entity to be assessed for risk), and generate the risk model features. Accordingly, as the risk model is trained, calibrated, retrained and the like, as discussed throughout this disclosure, the pre-processing operations may accordingly be reconfigured to generate the risk model features for each such iteration of the risk model. Likewise, post-processing may convert the output of the risk model to a form usable by customers of the open banking platform by, for example, converting tokenized vectors to natural language, converting the output to a scaled score and/or tiered value, appending metadata to the output, or otherwise preparing the output for transmission as part of a response from the risk model API and web portal to the requesting customer or other device.

The risk model proposed herein may be trained, calibrated, retrained, and its pre- and post-processing operations may be correspondingly configured and reconfigured, to generate risk determinations having high accuracy and precision. The features, also called feature outputs, as well as the overarching risk determinations, also called risk model outputs, may individually, collectively and/or respectively be analyzed to determine accuracy, precision or other quality metrics, as discussed in more detail below with respect to various stages of risk model generation, test data generation, risk model testing, risk model deployment and API platform configuration, and deployed risk model monitoring operations discussed herein. Pre- and post-processing may include, for example where natural language processing and/or LLMs are included in the risk model or another ML model utilizing tokenized vectors is utilized, translation to and from such tokenized vectors within the scope of the present invention.

Input data for the risk model may be variously constituted according to particularized embodiments of the present invention and the stage of risk model evolution and testing. Generally, input data for the risk model comprises a set or vector input of feature values. The input data may comprise open banking platform data, credit bureau data, and/or other financial data relating to the putative transacting entity (e.g., as discussed above) who is to be assessed for a risk aspect and/or to the broader environment or circumstances impacting the risk aspect(s) of the putative transaction (e.g., prime interest rate, exchange rate(s), or other broader or external factor(s)).

Open banking test data may be obtained from various data sources, including from data subjects, customers, financial institutions or service providers, or other sources. The input data sources may comprise open banking data, financial institution (FI) data regarding data subjects and/or FI terms and rate limits, account records, transaction and credit card data, firmographic entity data, location data, value data, regulatory data, personally identifiable information (PII), entity identification and/or authentication data, and/or other financial and relevant data. It should also be noted that the input data sources may comprise textual data, audio recordings and/or data and/or image data (e.g., images, videos, emojis, unstructured text, labeled/structured text, and the like) within the scope of the present invention.

Open banking test data or input data may be curated for training, retraining and/or calibration of the risk model, and/or, wherever applicable, as part of prompt engineering efforts to improve the input and corresponding risk model outputs. Input data may be curated, as noted above, in particularized ways depending on the stage of evolution and testing of the risk model set forth herein. That is, while the features and composition of the risk model itself (e.g., node weightings in a neural network) may change in connection with training, retraining and/or calibration of the risk model, so too may the values of the input data be curated to reach specific goals of a given stage.

For example, input data used for testing the risk model and/or its features, also referred to as open banking test data, may be retrieved (e.g., may comprise historical open banking platform data (e.g., transaction records) including the data needed for populating and/or deriving/calculating the risk model features) and/or may be curated, selected or simulated using algorithm(s) for test data generation. In one or more embodiments, open banking test data may be curated and/or generated by observing or calculating one or more statistical measures. For example, the service device 16 may analyze historical trends among one or more customer types or generally with respect to queries issued to the open banking service platform for the risk determinations. Number of queries per unit time, input data included with the queries, other input data gathered for processing the queries, computing resources available and consumed responsive to the queries (if variable), and other factors impacting generation of risk determination responses to queries may be determined from analysis of historical platform records to build a profile for curating test data to simulate likely scenarios a deployed risk model may face.

For example, risk determination queries from a first customer in a given historical record data set—the first customer being categorized in a particular business service domain—may be analyzed by the service device 16 to determine average queries per day over the relevant period, an average input data profile for various values included in those queries (which often varies, possibly along with the vector set input to the risk model, according to business service domain), along with other potentially relevant trends or averages (and/or maxima/minima for data values).

Similarly, relevant trends and aspects of the data and risk determination queries of a second customer in another business service domain may be determined from analysis of historical records covering a similar or the same relevant period. Accordingly, test scenarios may be developed from analysis of historical records reflecting queries to the risk model, including as delineated according to customer type.

More particularly, these determinations may together comprise simulated scenarios or descriptions of events or queries the risk model may be expected to encounter upon deployment. The corresponding averages, maxima/minima, query volumes and other data profile characteristics determined from such analysis of historical queries may be considered boundary conditions for generating or selecting input data test values for inclusion in corresponding simulated scenario test data sets emulating historical demands on the risk model. As noted above, the simulated scenario test data sets may be generated or otherwise curated according to customer type(s) and/or open banking service business domains. In one or more embodiments, such simulated scenario test data sets may be used as input to the risk model during benchmark testing and/or dog-food testing, discussed in more detail below. It should also be noted that many stages of testing described herein may simply rely on open banking test data comprising historical open banking platform data which has not been curated and which includes records of past queries for risk determinations and which may be input to the risk model.

It should also be noted that overfitting is a risk with ML risk models. Overfitting occurs when an algorithm fits too closely or even exactly to its training data, resulting in a model that does not make accurate predictions or conclusions from any data other than the training data. To address such concerns, the seed data and/or boundary conditions used to curate the training data may be randomly or pseudo-randomly varied to generate variance in the training data and determine whether overfitting applies to any iteration of the risk model, for example during functional validation, discussed in more detail below. More particularly, functional validation may include varying seed inputs and analyzing the functional validation risk determination outputs to determine whether the risk model is overfit to training data.

The ML program(s) comprising the risk model may be trained, retrained and/or calibrated to recognize or determine correlations between realized risk in one or more aspects of a putative open banking transaction on the one hand, and input data and/or open banking platform and other financial-related data on the other hand.

The ML techniques or programs may include curve fitting, regression model builders, convolutional or deep learning neural networks such as large language models (LLMs), combined deep learning, pattern recognition, or the like. The risk model may utilize classification algorithms such as Bayesian classifiers and decision trees, sets of pre-determined rules, and/or other algorithms. Based upon this data analysis, the ML program(s) may learn method(s) for curating test data (e.g., determining boundary conditions and scenarios and using same to generate simulated scenario test data sets), configuring respective pre- and post-processing operations for input data and outputs (including, for example, prompt engineering), and/or computing feature and risk determination outputs.

It should be noted that, in supervised machine learning, the risk model may be provided with example inputs (e.g., training data discussed herein and the like) and their associated outputs (e.g., realized risk for one or more aspects of open banking transactions), and may seek to discover a general rule that maps inputs to outputs for improved curation of test data, configuration of respective pre- and post-processing operations for input data and outputs, and/or computation of feature and risk determination outputs. In unsupervised machine learning, the risk model may be required to find its own structure in unlabeled example inputs.

Moreover, in one or more embodiments, the risk model is provided input via, and transmits its outputs via, an application programming interface (API). Accordingly, the risk model may be implemented or included in an API platform at various stages of development, testing and/or deployment. Implementation within the API platform may include aligning and configuring the pre-trained risk model with pre- and post-processing programs or algorithms for the model, configuring the risk model and pre- and post-processing operations for operation within the API, and other steps apparent to those having ordinary skill in the art. Similarly, the risk model implemented with the API platform may be deployed to a web portal (e.g., a test web portal simulating a production environment and/or a production web portal) at various stages of development, testing and/or deployment, again as discussed in more detail below. It should again be noted that the API platform and/or web portal may be hosted on a server 14 within the scope of the present invention.

Further, and as noted above, feature and risk determination outputs may be subjected to data analyses to determine precision, accuracy or other data quality metrics at various stages of embodiments of the present invention. The metrics may reflect internal consistency of the outputs across multiple test data queries, distributions of the outputs, comparisons of the outputs against historical outputs of prior/other risk models and/or prior iterations of the same risk model, comparisons of the outputs against expected outputs (whether expected outputs are manually determined calculated and/or automatically generated by algorithm), and/or other evaluations of precision and/or accuracy. One of ordinary skill will appreciate that a variety of statistical measures are available to analyze precision and/or accuracy. However, embodiments of the present invention specifically assess accuracy or precision, at times according to particularized metrics, to realize unexpected benefits at enumerated stages of development, implementation and/or deployment, as discussed in more detail below.

Moreover, embodiments of the present invention analyze performance of the risk model, API platform and/or corresponding web portal according to various statistical measure to inform risk model development, calibration and/or retraining. For example, load testing of the API platform with the risk model may be conducted and the outputs analyzed according to one or more of the following metrics for the outputs: time to calculate features (e.g., pre-processing), time to prediction (e.g., to risk determination output), and end-to-end time (e.g., overall process time). More specific metrics may include median/p99 open banking pipeline response time and/or median/p99 risk model prediction time. The results may be compared to acceptance and/or performance criteria which, in turn, may be derived or developed from analysis of service level agreements (SLAs) with customers of open banking platform services. The comparison may be used to conduct retraining and/or calibration of the risk model, as discussed in more detail below.

Turning now to a general discussion of embodiments of the present invention, testing a risk model trained to output a risk determination for open banking transactions may proceed broadly in stages. Namely, such testing may include data preparation, model development, deployment and post-deployment stages. It should be noted that despite ordered discussion of such stages discussed generally below, testing may proceed in the order shown and listed above and/or in a different order, for example where a later stage or sub-stage prompts iterative and/or feedback retraining, calibration or the like according to an earlier stage or sub-stage. For ease of description, the possibility of returning to earlier stage(s) and/or sub-stages should be understood without the need for repetition throughout this disclosure.

The data preparation stage may be conducted in a local environment, such as at a service device 16 and/or server 14 of the open banking platform. Data preparation may include operations or processes for preparing test or training data for risk model training, risk model feature validation, test or training data labeling, unit testing, and functional testing.

Data extraction may include test or training data extraction from historical records and/or curation of simulated data for feature values, as discussed in more detail above. The training or test data may be labeled according to preferred outcomes or values for feature and/or risk determination outputs, as the case may be. Feature generation for the risk model may be performed to, for example, define the relevant datapoints or data representations to be included in risk model inputs (e.g., vectors), and may be defined by regression techniques or otherwise as known to one having ordinary skill in the art.

Feature generation and labeling may be performed based on and/or iteratively with feature validation and unit testing steps. For example, feature validation may include automated and manual generation of expected outcomes or values for feature and/or risk determination outputs of the risk model, and feature generation may be iteratively performed until acceptable accuracy relative to such expected outcomes is achieved. The expected outcomes or values may be generated with reference to the boundary conditions for one or more scenarios and/or customer types discussed in more detail above.

For example, manual feature validation may include an expert calculating, for a hypothetical test account on a particular day, a balance. The automated feature validation may include tasking a program (e.g., code or script) for test data generation to calculate such a balance. In each case, the balance is a feature of the risk model, and feature validation seeks to improve accurate calculation of the feature value within the risk model relative to the expected outcomes. Such feature validation may be performed iteratively within the scope of the present invention and may support corresponding iterative calibrations of feature calculation (e.g., pre-processing operations and/or risk model composition) throughout. Acceptance criteria for such accuracy may guide how and to what extent additional calibration and/or re-training are needed based on feature validation operations.

Unit testing seeks to isolate or otherwise make independently testable discrete units or portions of the risk model and/or the API platform, preferably at the smallest or a significantly fragmented level so as to better localize any sources of inaccuracy, imprecision, latency or the like. One of ordinary skill will appreciate that discrete units may share certain overlapping segments and/or features of the risk model within the scope of the present invention.

Feature validation supports feature generation processes, and unit testing supports labeling processes. Conversely, feature generation in some senses precedes feature validation, and labeling precedes and is required for unit testing, in each case in an iterative and/or feedback loop. Moreover, unit testing results may be incorporated into the feature generation/feature validation loop to improve feature generation.

The data preparation may also include functional testing of the risk model and risk determination outputs more generally. As noted above, the functional testing may be performed periodically and/or at various stages, to ensure at least a minimum level of viability (e.g., accuracy, precision, adherence to business requirements, and the like) relative to the corresponding stage of development. The feature outputs and/or risk determination outputs may be compared according to various precision and accuracy statistical measures to make such determinations.

Turning to the risk model development stage, this may occur in the local environment in one or more embodiments. During this stage, risk model composition determinations may be finalized or implemented. Moreover, the risk model may be trained, including according to the techniques and with training data discussed in more detail above. Thresholds for the risk model—such as those for acceptance criteria relating to feature and/or risk determination output accuracy, precision or the like—may also be determined, including with reference to prior model performance, market expectations, SLAs and/or other sources of product requirements. These may collectively be developed and referred to as model performance metrics.

The model development stage may include model validation, according to which the risk determination outputs (using open banking open banking test data as inputs, according to the vectors and features developed in the data preparation phase) are generated and compared and analyzed using the performance metrics and compared to acceptance criteria and corresponding calibrated thresholds.

Model validation supports model training and threshold calibration processes. Conversely, model training and threshold calibration in some senses precedes model validation, in each case in an iterative and/or feedback loop. Functional testing may also be performed one or more times at the model development stage.

Turning to the “deployment” stage, several sub-stages associated with preparing the risk model for deployment and implementing that deployment are illustrated. The sub-stages may roughly be grouped as or comprise system testing and performance testing operations. For example, a portion of the deployment stage may be conducted in a development environment (e.g., at the service device 16 and/or server 14). The risk model may be integrated into or implemented with the API platform during the deployment stage. The development environment may be configured to simulate real-world or deployment conditions and scenarios, and, accordingly, testing of the risk model implemented with the API platform may be conducted, particularly during benchmark testing, using simulated scenario test data sets corresponding to business domains and generated with corresponding boundary conditions, as discussed in more detail above. Acceptance criteria for the benchmark testing may include assessment according to one or more of the following metrics and/or analyses/plots: an overall match score; a risk score decile match; one or more risk score indicator comparison tables; a score indicator distribution overall percentage match comparison; an overall score comparison; a feature set comparison; a day wise score decile distribution comparison; and a movement analysis.

Unit testing, in the manner discussed above, may also/again be conducted in the development environment. Further, load testing may be performed in the development environment. Load testing to the risk model implemented with the API platform in the development environment may assess model performance by inputting open banking test data extracted, selected or otherwise curated for pressure testing according to customer types defined by query frequency/volume patterns over time (i.e., assessing how the model performs for a first customer type with a query frequency/volume profile over time of a first type, for a second customer type with a different query frequency/volume profile, etc.). Again, the risk determination outputs and model performance may be evaluated according to one or more of time to calculate features (e.g., pre-processing), time to prediction (e.g., to risk determination output), and end-to-end time (e.g., overall process time), in each case with reference to one or more customer types. The results may be compared to acceptance and/or performance criteria which, in turn, may be derived or developed from analysis of service level agreements (SLAs) with customers of open banking platform services having various types.

The deployment stage also includes deployment to the test or production web portal of the production environment for dog-fooding. Dog-fooding includes testing on scenarios developed to simulate real-world and/or extrema that might be encountered in real-world conditions. In one or more embodiments, the dog-fooding includes generating simulated scenario test data sets using derived boundary conditions (discussed above) selected for stressing the risk model according to extrema of those conditions and/or to otherwise simulate real-world conditions. The results, including as analyzed against acceptance criteria and/or using threshold and/or performance metrics, may be provided to customers for evaluation and acceptance. In one or more embodiments, simulating real-word performance in dog-food testing includes connecting simulated or real open banking customer accounts to the web portal integrated risk model API platform and conducting the dog-fooding by inputting the test data via the open banking customer accounts to generate risk determination outputs for evaluation and acceptance.

Turning now to the post-deployment stage, the web portal integrated risk model API platform in a production environment (e.g., hosted on a server 14) may be periodically subjected to model governance processes. The web portal integrated risk model API platform may be periodically subjected to bias testing and monitored for data drift.

The bias testing may include testing the risk model outputs for group fairness and bias by analyzing outputs of the risk model to determine whether the outputs show one or both of equal false negative rates or equal acceptance rates, in each case across a plurality of pre-determined social groups.

The data drift monitoring may include monitoring and parsing model logs to identify occurrence of one or more of: drift of risk determination outputs of the production risk model; feature (covariate) drift of the production risk model; and concept drift.

Model governance processes, bias testing results, data drift monitoring, and/or other model performance observations may be reported out and/or otherwise made available, including at a dashboard populated with such information (e.g., displayed at the service device 16 and/or client device 12). The dashboard feature may include generating a user interface comprising the dashboard and, based on data extracted by the parsing of the model logs, populating the dashboard with one or more of the following data types: reported errors; processing volumes; production risk model outcomes; processing times; performance metrics delineated according to customer types; and multi-partner monitoring metrics.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method for Open Banking Risk Model Test Framework

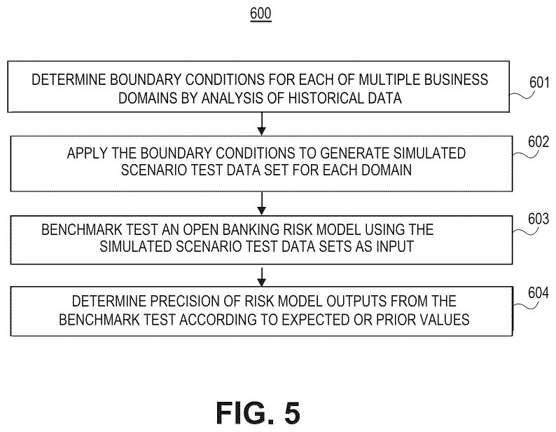

FIG. 5 depicts a flowchart including a listing of steps of an exemplary computer-implemented method 600 for testing a risk model trained to output a risk determination for open banking transactions. The steps may be performed in the order shown in FIG. 5, or they may be performed in a different order. Furthermore, some steps may be performed concurrently as opposed to sequentially. In addition, some steps may be optional.

The computer-implemented method 600 is described below, for ease of reference, as being executed by exemplary devices and components introduced with the embodiments illustrated in FIGS. 1-4. For example, the steps of the computer-implemented method 600 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 601, boundary conditions may be determined for each of multiple business domains by analysis of historical data. In one or more embodiments, the analysis may be performed in a local and/or development environment and/or by a service device and/or open banking service platform server (e.g., one or more of devices 14, 16).

As discussed above, open banking test data may be curated and/or generated by observing or calculating one or more statistical measures. For example, the service device may analyze historical trends among one or more customer types or generally with respect to queries issued to the open banking service platform for the risk determinations. Number of queries per unit time, input data included with the queries, other input data gathered for processing the queries, computing resources available and consumed responsive to the queries (if variable), and other factors impacting generation of risk determination responses to queries may be determined from analysis of historical platform records to build a profile for curating test data to simulate likely scenarios a deployed risk model may face.

For example, risk determination queries from a first customer in a given historical record data set—the first customer being categorized in a particular business service domain—may be analyzed by the service device to determine average queries per day over the relevant period, an average input data profile for various values included in those queries (which often varies, possibly along with the vector set input to the risk model, according to business service domain), along with other potentially relevant trends or averages (and/or maxima/minima for data values).

Similarly, relevant trends and aspects of the data and risk determination queries of a second customer in another business service domain may be determined from analysis of historical open banking records covering a similar or the same relevant period. Accordingly, test scenarios may be developed from analysis of historical records reflecting queries to the risk model, including as delineated according to customer type.

More particularly, these determinations may together comprise simulated scenarios or descriptions of events or queries the risk model may be expected to encounter upon deployment. The corresponding averages, maxima/minima, query volumes and other data profile characteristics determined from such analysis of historical queries may be considered the boundary conditions for generating or selecting input data test values for inclusion in corresponding simulated scenario test data sets emulating historical demands on the risk model.

In one or more embodiments, the boundary condition sets (and corresponding test data sets discussed below) are organized or categorized according to business domains (e.g., groups of services provided by the customers and/or open banking services enrolled in and/or utilized by the customers). In one or more embodiments, business domain categorization may be based on merchant category code (MCC) and/or other standardized taxonomy(ies). The business domain categorization may also or alternatively rely on volume of requests or queries issued to the risk model, for example according to tiered ranges of queries per unit time. The historical open banking platform data analyzed to generate business domain categories and/or classify customers according to same may include unique identifying information for each customer which may be used to organize the open banking service business domains in accordance with the open banking services the customers are respectively enrolled in.

Moreover, it should be noted that boundary conditions may be limited to or particularly focused on key features of the risk model. That is, additional analysis to arrive at more finely tuned boundary conditions may be performed with respect to features of the risk model known or determined to be particularly influential or more heavily weighted in the generation of risk determinations. Because the set of key features may vary depending on the business domain at issue, each distinct set of boundary conditions may vary based on the key features associated with the corresponding business domain category.

Referring to step 602, one or more simulated scenario test data set(s) may be generated through application of the boundary conditions. In one or more embodiments, the generation may be performed in a local and/or development environment and/or by a service device and/or open banking service platform server (e.g., one or more of devices 14, 16).

As noted above, the simulated scenario test data sets may be generated or otherwise curated according to customer type(s) and/or open banking service business domains. For example, data may be extracted from existing historical transaction records which meets the boundary conditions and/or data may be generated by a test data generation algorithm to meet the boundary conditions. In one or more embodiments, a simulated scenario test data set is generated for each of the business domain categories to be tested.

Referring to step 603, the open banking risk model may be benchmark tested using the simulated scenario test data sets as input for generation of risk determinations. In one or more embodiments, the benchmark testing may be performed in a development environment and/or by a service device and/or open banking service platform server (e.g., one or more of devices 14, 16). In one or more embodiments, the open banking risk model is implemented with an API platform for the benchmark testing.

More particularly, the simulated scenario test data sets may be used as input to the risk model during benchmark testing to generate corresponding risk determination outputs.

Referring to step 604, a precision may be determined for the risk determination outputs of the benchmark testing according to expected or prior values. In one or more embodiments, the precision determination may be performed in a development environment and/or by a service device and/or open banking service platform server (e.g., one or more of devices 14, 16).

In one or more embodiments, the precision determination includes or supports analysis of acceptance criteria for the benchmark testing according to one or more of the following metrics and/or analyses/plots: an overall match score; a risk score decile match; one or more risk score indicator comparison tables; a score indicator distribution overall percentage match comparison; an overall score comparison; a feature set comparison; a day wise score decile distribution comparison; and a movement analysis.

Moreover, based on the precision determination and comparison to acceptance criteria, the risk model may be retrained or calibrated. The benchmark testing may be repeated on the retrained or calibrated risk model, for example using the same simulated scenario test data sets as input, to generate corresponding second risk determinations for the banking service business domains. The performance and precision metrics may be again computed, and the cycle repeated until the acceptance criteria is met.

The method may include additional, less, or alternate steps and/or device(s), including those discussed elsewhere herein, unless otherwise expressly stated and/or readily apparent to those skilled in the art from the description.

For example, the benchmark testing and related steps described above may be performed in conjunction with the load testing method 700 described in more detail below, as part of the method 800 described in more detail below, and/or in conjunction with or as otherwise described in other portions of this disclosure.

### Exemplary Computer-Implemented Method for Open Banking Risk Model Test Framework

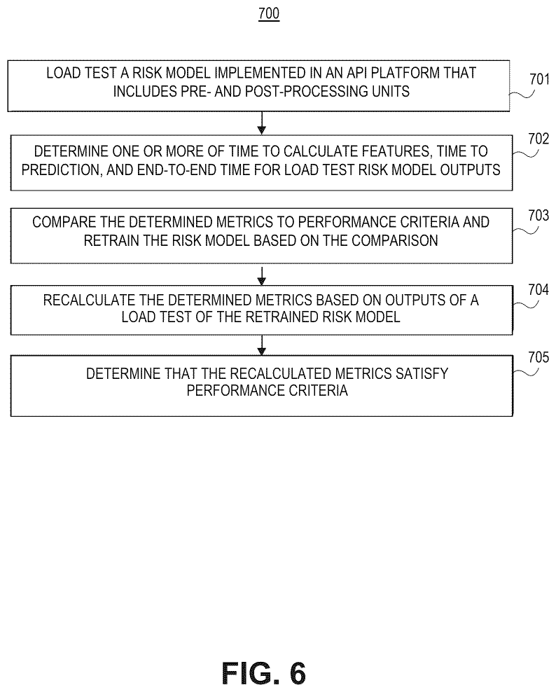

FIG. 6 depicts a flowchart including a listing of steps of an exemplary computer-implemented method 700 for testing a risk model trained to output a risk determination for open banking transactions. The steps may be performed in the order shown in FIG. 6, or they may be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-4. For example, the steps of the computer-implemented method 700 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 701, a risk model implemented in an API platform including pre- and post-processing units may be load tested. In one or more embodiments, the load testing may be performed in a local and/or development environment and/or by a service device and/or open banking service platform server (e.g., one or more of devices 14, 16).

As discussed above, load testing to the risk model implemented with the API platform may assess model performance by inputting open banking test data extracted, selected or otherwise curated for pressure testing according to customer types defined by query frequency/volume patterns over time (i.e., assessing how the model performs for a first customer type with a query frequency/volume profile over time of a first type, for a second customer type with a different query frequency/volume profile, etc.). Accordingly, in one or more embodiments, simulated scenario test data sets corresponding to the customer types and generated in reliance on respective boundary condition sets may be used as input data for load testing.

The risk model implemented with the API platform may, responsive to the inputted open banking test data curated for pressure testing, generate risk determination outputs.

Referring to step 702, one or more metrics or metric values for the load test risk determination outputs may be determined, including one or more of a time to calculate features, a time to prediction, and an end-to-end time. In one or more embodiments, the metric determinations may be performed in a local and/or development environment and/or by a service device and/or open banking service platform server (e.g., one or more of devices 14, 16).

In each case, the time to calculate features (e.g., pre-processing), time to prediction (e.g., to risk determination output), and end-to-end time (e.g., overall process time) may be determined with reference to the one or more customer types assessed by the load test. More specific metrics may include median/p99 open banking pipeline response time and/or median/p99 risk model prediction time. One of ordinary skill will appreciate that other pressure or load test metrics may be used to assess performance of the risk model implemented with the API platform.

Referring to step 703, the metrics or metric values determined according to step 702 may be compared to performance criteria and corresponding deficiencies may be addressed by retraining the risk model based thereon. In one or more embodiments, the comparison and/or retraining may be performed in a local and/or development environment and/or by a service device and/or open banking service platform server (e.g., one or more of devices 14, 16).

The acceptance and/or performance criteria may be derived or developed from analysis of service level agreements (SLAs) with customers of open banking platform services having various types. For example, an SLA may require a p99 response time or latency metric of less than two (2) seconds.

It should also be appreciated that one or more SLAs may apply distinctly to each customer type assessed by the load test and any retraining or calibration conducted based on the comparison to acceptance and/or performance criteria may accordingly be dependent on customer type. Because query frequency/volume profiles, input data, and SLA requirements, for example, vary by customer type, the corresponding retraining and/or calibration may be conducted in view of these differences.

For example, a first customer type may require less accuracy (while providing less input data for the risk model) but shorter computational time, whereas a second customer type may require greater accuracy (while providing more input data for the risk model) and allowing for greater response or computational time. Accordingly, retraining the risk model in view of the first customer type may include returning to the feature generation step to reduce the number of features prior to repeating the load test (see discussion below), and/or retraining the risk model in view of the second customer type may include a compromise with the goals of retraining for the first customer type to include improved accuracy despite a reduced number of features (e.g., through reliance on other features which are not disruptive of the computational efficiency achieved through retraining for the first customer). One of ordinary skill will appreciate that a variety of retraining compromises are possible to achieve load test passage according to embodiments of the present invention.

Referring to step 704, the metrics or metric values determined according to step 702 may be recalculated based on second outputs generated from a second load test of the retrained risk model. In one or more embodiments, the recalculated metrics may be determined (and the second load test performed) in a local and/or development environment and/or by a service device and/or open banking service platform server (e.g., one or more of devices 14, 16).

Referring to step 705, it may be determined that the recalculated metrics satisfy the performance criteria. In one or more embodiments, the determination of performance criteria satisfaction may be made in a local and/or development environment and/or by a service device and/or open banking service platform server (e.g., one or more of devices 14, 16).

The method may include additional, less, or alternate steps and/or device(s), including those discussed elsewhere herein, unless otherwise expressly stated and/or readily apparent to those skilled in the art from the description.

For example, the load testing and related steps described above may be performed in conjunction with the benchmark testing method 600 described in more detail above, as part of the method 800 described in more detail below, and/or in conjunction with or as otherwise described in other portions of this disclosure.

### Exemplary Computer-Implemented Method for Open Banking Risk Model Test Framework

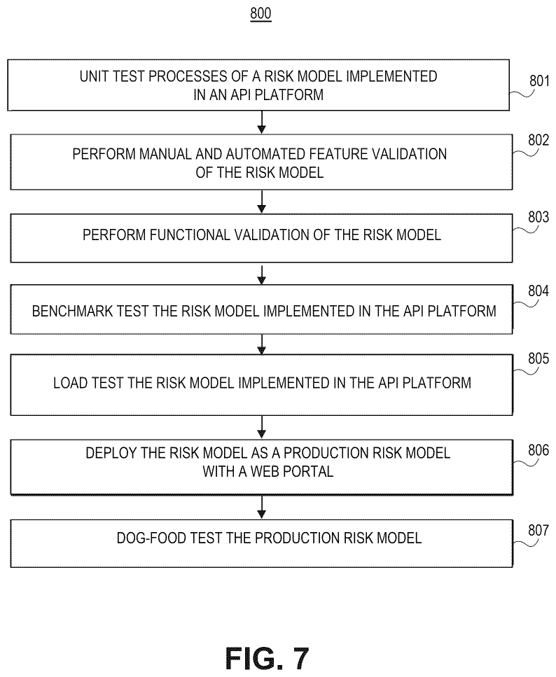

FIG. 7 depicts a flowchart including a listing of steps of an exemplary computer-implemented method 800 for testing a risk model trained to output a risk determination for open banking transactions. The steps may be performed in the order shown in FIG. 7, or they may be performed in a different order. Furthermore, some steps may be performed concurrently as opposed to sequentially. In addition, some steps may be optional.

The computer-implemented method 800 is described below, for ease of reference, as being executed by exemplary devices and components introduced with the embodiments illustrated in FIGS. 1-4. For example, the steps of the computer-implemented method 800 may be performed by the client devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 801, processes of a risk model implemented in an application programming interface (API) platform may be unit tested. In one or more embodiments, the unit testing may be performed in a local and/or development environment and/or by a service device and/or open banking service platform server (e.g., one or more of devices 14, 16).

Unit testing seeks to isolate or otherwise make independently testable discrete units or portions of the risk model and/or the API platform, preferably at the smallest or a significantly fragmented level so as to better localize any sources of inaccuracy, imprecision, latency or the like. One of ordinary skill will appreciate that discrete units may share certain overlapping segments and/or features of the risk model within the scope of the present invention.

Referring to step 802, manual and automated feature validation may be performed for the risk model. In one or more embodiments, the manual and automated feature validation may be performed in a local and/or development environment and/or by a service device and/or open banking service platform server (e.g., one or more of devices 14, 16).

Feature validation may include automated and manual generation of expected outcomes or values for feature and/or risk determination outputs of the risk model, and feature generation may be iteratively performed until acceptable accuracy relative to such expected outcomes is achieved. The expected outcomes or values may be generated with reference to boundary conditions for one or more scenarios and/or customer types, as discussed in more detail above.

For example, manual feature validation may include an expert calculating, for a hypothetical test account on a particular day, a balance. The automated feature validation may include tasking a program (e.g., code or script) for test data generation to calculate such a balance. In each case, the balance is a feature of the risk model, and feature validation seeks to improve accurate calculation of the feature value within the risk model relative to the expected outcomes calculated by the expert and/or program. The manually-generated expected values may be considered a first set of expected values for the features, and the automatically-generated expected values may be considered a second set of expected values for the features.

Such feature validation may be performed iteratively within the scope of the present invention and may support corresponding iterative calibrations of feature calculation (e.g., pre-processing operations and/or risk model composition) throughout. Acceptance criteria for such accuracy may guide how and to what extent additional calibration and/or re-training are needed based on feature validation operations.

Referring to step 803, functional validation of the risk model may be performed. In one or more embodiments, the functional validation may be performed in a local and/or development environment and/or by a service device and/or open banking service platform server (e.g., one or more of devices 14, 16).

The functional validation may include inputting open banking test data to the risk model to generate risk determination outputs. The risk determination outputs may be analyzed to determine accuracy according to one or more metrics. For example, accuracy may be assessed based on number and/or frequency of occurrence of false positives, false negatives or the like, in each case relative to the type of risk determination being undertaken. Moreover, overfitting may be determined, the input open banking test data varied correspondingly, as part of the functional validation testing and as discussed in more detail above.

The risk model may be retrained and/or the risk model and API platform may be calibrated based on the comparison of the functional validation risk determination outputs to accuracy metrics and/or accuracy performance criteria. The retrained and/or calibrated risk model may be retested for functional validation and the corresponding output may again be compared to such accuracy performance criteria until acceptable performance is reached.

Referring to step 804, the risk model implemented in the API platform may be benchmark tested. In one or more embodiments, the benchmark testing may be performed in a local and/or development environment and/or by a service device and/or open banking service platform server (e.g., one or more of devices 14, 16). The benchmark testing may be performed in accordance with and/or may include one or more steps described in connection with method 600 discussed above.

Referring to step 805, the risk model implemented in the API platform may be load tested. In one or more embodiments, the load testing may be performed in a local and/or development environment and/or by a service device and/or open banking service platform server (e.g., one or more of devices 14, 16). The load testing may be performed in accordance with and/or may include one or more steps described in connection with method 700 discussed above.

Referring to step 806, the risk model implemented in the API platform may be deployed as a production risk model with a web portal. In one or more embodiments, the risk model deployment may be to a production environment and/or to a service device and/or open banking service platform server (e.g., one or more of devices 14, 16).

Referring to step 807, the production risk model may be dog-food tested. In one or more embodiments, the dog-food testing may be performed in a production environment and/or by a service device and/or open banking service platform server (e.g., one or more of devices 14, 16).

Dog-fooding includes testing on scenarios developed to simulate real-world and/or extrema that might be encountered in real-world conditions. In one or more embodiments, the dog-fooding includes generating simulated scenario test data sets using derived boundary conditions (discussed above) selected for stressing the risk model according to extrema of those conditions and/or to otherwise simulate real-world conditions. The results, including as analyzed against acceptance criteria and/or using threshold and/or performance metrics, may be provided to customers for evaluation and acceptance. In one or more embodiments, simulating real-word performance in dog-food testing includes connecting simulated or real open banking customer accounts to the web portal integrated risk model API platform and conducting the dog-fooding by inputting the test data via the open banking customer accounts to generate risk determination outputs for evaluation and acceptance.

The method may include additional, less, or alternate steps and/or device(s), including those discussed elsewhere herein, unless otherwise expressly stated and/or readily apparent to those skilled in the art from the description.

For example, the steps described above may be performed in conjunction with any one or more steps of the method 600 and/or of the method 700 described in more detail above, and/or in conjunction with or otherwise described in other portions of this disclosure.

Moreover, it should again be noted that any testing and/or performance criteria comparison may comprise a feedback loop for retraining or calibration to another stage or sub-stage described herein without departing from the spirit of the present invention. For example, in one or more embodiments, manual and feature validation is iterated. The risk model may be retrained or calibrated based at least in part on the manual and automated feature validation, with the manual and automated feature validation being repeated by comparing additional feature outputs from each retrained risk model to additional expected feature output values. The repeated manual feature validation may include repeated manual generation of additional expected feature output values and repeated automated feature validation may include repeated automated generation of corresponding additional expected feature output values.

For another example, the determination of an accuracy metric for the functional validation may include analyzing predicted score distributions comprising the functional validation risk determination outputs. The method may include retraining or calibrating the risk model based at least in part on the functional validation and repeating the functional validation for the retrained risk model by comparing additional risk determination outputs of the retrained risk model to the expected values for the additional functional validation risk determination outputs to redetermine performance according to the accuracy metric.

Further, the web portal integrated risk model API platform may be periodically subjected to bias testing and monitored for data drift.

The bias testing may include testing the risk model outputs for group fairness and bias by analyzing outputs of the risk model to determine whether the outputs show one or both of equal false negative rates or equal acceptance rates, in each case across a plurality of pre-determined social groups.

The data drift monitoring may include monitoring and parsing model logs to identify occurrence of one or more of: drift of risk determination outputs of the production risk model; feature (covariate) drift of the production risk model; and concept drift.

Still further, bias testing results, data drift monitoring, and/or other model performance observations may be reported out and/or otherwise made available, including at a dashboard populated with such information (e.g., displayed at the service device 16 and/or client device 12). The dashboard feature may include generating a user interface comprising the dashboard and, based on data extracted by the parsing of the model logs, populating the dashboard with one or more of the following data types: reported errors; processing volumes; production risk model outcomes; processing times; performance metrics delineated according to customer types; and multi-partner monitoring metrics.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. Non-transitory computer-readable storage media having computer-executable instructions stored thereon for testing a risk model trained to output a risk determination for open banking transactions, wherein when executed by at least one processor the computer-executable instructions cause the at least one processor to:
analyze historical open banking platform data according to a plurality of open banking service business domains to determine a set of boundary conditions for each of the business domains;
apply the sets of boundary conditions to generate a plurality of simulated scenario test data sets, each of the plurality of simulated scenario test data sets corresponding to one of the plurality of business domains;
benchmark test the risk model, the risk model being implemented in an application programming interface (API) platform, using the plurality of simulated scenario test data sets as input to generate corresponding outputs comprising risk determinations for each of the plurality of open banking service business domains; and
determine precision of the outputs according to expected or prior values.

2. The non-transitory computer-readable storage media of claim 1, wherein the computer-executable instructions further cause the at least one processor to identify merchant category codes (MCCs) corresponding to the historical open banking platform data, the plurality of open banking service business domains being organized according to the MCCs.

3. The non-transitory computer-readable storage media of claim 1, wherein the computer-executable instructions further cause the at least one processor to attribute a plurality of risk determination requests comprising the historical open banking platform data to a plurality of open banking customers and to organize the open banking service business domains based on open banking services the open banking customers are enrolled in.

4. The non-transitory computer-readable storage media of claim 1, wherein the determination of the set of boundary conditions for each of the business domains includes implementing a plurality of key feature definitions.

5. The non-transitory computer-readable storage media of claim 1, wherein the computer-executable instructions further cause the at least one processor to retrain or calibrate the risk model based at least in part on the precision determination and to repeat the benchmark test using the plurality of simulated scenario test data sets as input to generate corresponding second outputs comprising risk determinations for each of the plurality of open banking service business domains.

6. The non-transitory computer-readable storage media of claim 1, wherein the computer-executable instructions further cause the at least one processor to generate a benchmark test report including one or more of: an overall match score; a risk score decile match; one or more risk score indicator comparison tables; a score indicator distribution overall percentage match comparison; an overall score comparison; a feature set comparison; a day wise score decile distribution comparison; and a movement analysis.

7-20. (canceled)

21. A system comprising:
a processor; and
a memory storing computer-executable instructions thereon, the computer-executable instructions, when executed by the processor, causing the processor to perform operations of—
analyzing historical open banking platform data according to a plurality of open banking service business domains to determine a set of boundary conditions for each of the business domains;
applying the sets of boundary conditions to generate a plurality of simulated scenario test data sets, each of the plurality of simulated scenario test data sets corresponding to one of the plurality of business domains;
benchmark testing the risk model, the risk model being implemented in an application programming interface (API) platform, using the plurality of simulated scenario test data sets as input to generate corresponding outputs comprising risk determinations for each of the plurality of open banking service business domains; and
determining precision of the outputs according to expected or prior values.

22. The system of claim 21, wherein the computer-executable instructions further cause the processor to identify merchant category codes (MCCs) corresponding to the historical open banking platform data, the plurality of open banking service business domains being organized according to the MCCs.

23. The system of claim 21, wherein the computer-executable instructions further cause the processor to attribute a plurality of risk determination requests comprising the historical open banking platform data to a plurality of open banking customers and to organize the open banking service business domains based on open banking services the open banking customers are enrolled in.

24. The system of claim 21, wherein the determination of the set of boundary conditions for each of the business domains includes implementing a plurality of key feature definitions.

25. The system of claim 21, wherein the computer-executable instructions further cause the processor to retrain or calibrate the risk model based at least in part on the precision determination and to repeat the benchmark test using the plurality of simulated scenario test data sets as input to generate corresponding second outputs comprising risk determinations for each of the plurality of open banking service business domains.

26. The system of claim 21, wherein the computer-executable instructions further cause the processor to generate a benchmark test report including one or more of: an overall match score; a risk score decile match; one or more risk score indicator comparison tables; a score indicator distribution overall percentage match comparison; an overall score comparison; a feature set comparison; a day wise score decile distribution comparison; and a movement analysis.

27. A computer-implemented method for testing a risk model trained to output a risk determination for open banking transactions, the method comprising:
analyzing historical open banking platform data according to a plurality of open banking service business domains to determine a set of boundary conditions for each of the business domains;
applying the sets of boundary conditions to generate a plurality of simulated scenario test data sets, each of the plurality of simulated scenario test data sets corresponding to one of the plurality of business domains;
benchmark testing the risk model, the risk model being implemented in an application programming interface (API) platform, using the plurality of simulated scenario test data sets as input to generate corresponding outputs comprising risk determinations for each of the plurality of open banking service business domains; and
determining precision of the outputs according to expected or prior values.

28. The computer-implemented method of claim 27, comprising identifying merchant category codes (MCCs) corresponding to the historical open banking platform data, the plurality of open banking service business domains being organized according to the MCCs.

29. The computer-implemented method of claim 27, comprising attributing a plurality of risk determination requests comprising the historical open banking platform data to a plurality of open banking customers and to organize the open banking service business domains based on open banking services the open banking customers are enrolled in.

30. The computer-implemented method of claim 27, wherein the determination of the set of boundary conditions for each of the business domains includes implementing a plurality of key feature definitions.

31. The computer-implemented method of claim 27, comprising retraining or calibrating the risk model based at least in part on the precision determination and repeating the benchmark test using the plurality of simulated scenario test data sets as input to generate corresponding second outputs comprising risk determinations for each of the plurality of open banking service business domains.

32. The computer-implemented method of claim 27, comprising generating a benchmark test report including one or more of: an overall match score; a risk score decile match; one or more risk score indicator comparison tables; a score indicator distribution overall percentage match comparison; an overall score comparison; a feature set comparison; a day wise score decile distribution comparison; and a movement analysis.
